(19) United States
(12) Patent Application Publication
(10) Pub. No.: US 2025/0065739 A1
(43) Pub. Date: Feb. 27, 2025

(54) Wall charging station

(71) Applicant: Webasto SE, Stockdorf (DE)

(72) Inventors: Nadine Zisler, Stockdorf (DE); Daniela Wolff, Stockdorf (DE); Henning Adolph, Stockdorf (DE)

(21) Appl. No.: 18/694,819

(22) PCT Filed: Sep. 28, 2022
(86) PCT No.: PCT/EP2022/076934

§ 371 Date: Mar. 22, 2024

(30) Foreign Application Priority Data
Sep. 28, 2021 (DE) 10 2021 125 168.0

(51) Int. Cl. B60L 53/31; B33Y 10/00

(52) U.S. Cl. CPC B60L 53/31; B33Y 10/00; B60L 2250/16

(57) ABSTRACT

A wall charging station for charging electric vehicles and hybrid vehicles, comprising a cover having a light-guide element which comprises a light coupling point and a light-emitting cover section having a front side and a rear side, where the rear side has a light-reflecting element which is formed and configured to emit light incident from the light coupling point via the front side of the light-emitting cover section to the surroundings.

### CROSS-REFERENCE TO RELATED APPLICATIONS

This application is a 35 U.S.C. § 371 National Stage Entry of International Application No. PCT/EP2022/076934 filed Sep. 28, 2022, which claims the priority benefit of German Patent Application Serial Number DE 10 2021 125 168.0 filed Sep. 28, 2021, all of which are incorporated herein by reference in their entirety for all purposes.

### TECHNICAL FIELD

The present invention relates to a wall charging station for charging electric and hybrid vehicles, comprising a cover having a light guiding element, which comprises a light coupling point and a light-emitting cover section having a front side and a rear side.

### BACKGROUND OF THE INVENTION

The proportion of electric and hybrid vehicles, referred to hereinafter for the sake of simplicity as “electric vehicles”, is growing continuously. The demand is also accordingly growing for recharging vehicle batteries for storing electrical energy, for example, in the form of rechargeable traction batteries of such an electric vehicle. This is implemented, inter alia, using wall charging stations, also called wall boxes. Such wall charging stations are installed, for example, at public parking spaces. Alternatively, wall charging stations are also found in the private customer area, where they can be installed, for example, in carports or garages on the wall.

The propagation of wall charging stations is accompanied by a high demand for safe, easily operable, and visually appealing wall charging stations. Wall charging stations have to fulfill multiple functions in this case. On the one hand, wall charging stations have to offer a high level of security against destruction by external force action. Users of the wall charging station then themselves have to be protected from life-threatening electric shocks, when they have been subjected to impacts, strikes, or a collision with a vehicle. At the same time, the internal components of the wall charging station have to be protected by their cover from dirt, moisture, or other substances potentially harmful to the electrical components. In addition, it can be necessary to integrate additional functionalities, such as an authorization of the user, in the wall charging station, which in most cases comprise a visual display of information to the user on the cover. It is critical here to be able to provide such information on the cover independently of weather, time of day, and/or external light sources.

Wall charging stations made of plastic parts manufactured by injection molding are known from the prior art, for example, according to which a cover part has one or more viewing windows having light sources arranged flush and located behind them. However, this approach has the disadvantage that due to the viewing window having light sources, the geometry of the cover has to be changed. The cover has to be designed as overall more protruding, in order to accommodate the additional components. However, the enlarged structure also increases the risk that an operator, a vehicle, or another object collides with the cover of the wall charging station. In addition, the stability of the wall charging station can be impaired by the provision of the viewing window having light sources.

A further approach known from the prior art suggests coupling light from a light source laterally into a viewing window and thus generating an illuminated section in the cover of the wall charging station. However, this approach has the disadvantage that actually only small fractions of the coupled-in light are emitted as externally visible light. Therefore, such viewing windows often have a merely very weakly pronounced light power. Such viewing window lights are therefore only suitable as background lighting in darkness. In contrast, such viewing window lights are not suitable for emitting light signals in daylight.

### DESCRIPTION OF THE INVENTION

Starting from the known prior art, it is an object of the present disclosure to provide an improved wall charging station for charging electric and hybrid vehicles. It is in particular an object of the present invention to provide a lighted area in the cover of a wall charging station in a simple, reliable, and cost-effective manner, which enables the most efficient possible light emission.

Said object is achieved by a wall charging station having the features of claim 1. Advantageous embodiments are depicted in the dependent claims, the description, and the Figures.

The present invention is based on the concept of providing a wall charging station for charging electric and hybrid vehicles, wherein the wall charging station comprises a cover having a light guiding element, which comprises a light coupling point and a light-emitting cover section having a front side and a rear side.

According to the invention, the rear side of the cover section has a light-reflecting element which is formed and configured to emit light incident from the light coupling point via the front side of the light-emitting cover section to the surroundings.

In other words, the concept of the invention is based on the approach of coupling light from a light source arranged in the interior of the wall charging station into a light guiding element and specifically emitting the coupled-in light to the surroundings via a separately provided light-reflecting element.

The light coupling point can be arranged outside and behind the rear side of the light-emitting cover section.

The term “light guiding element” in the sense of the present disclosure means a transparent or translucent body in which light can be conducted at least in some sections by means of total reflection, as occurs in light guides according to the physical laws of refraction. However, the term “light guiding element” in the sense of the present disclosure also means a body, which is suitable for deflecting light coupled in at a separately provided section into light that is emitted to the surroundings.

The term “coupled-in light” in the sense of the present disclosure means the conduction of light in such a light guide. Accordingly, in the sense of the present disclosure, the term “coupling” refers to the introduction of light into a light guide and the term “decoupling” refers to the discharge or emission of light from a light guide. A light coupling point in the sense of the present disclosure can mean a part of a light guide having a surface, via which light can be coupled into the light guide or into the light guiding element. The term “emitting of light”, in contrast, in the sense of the present disclosure means the literal, diffuse or directed emission of light, for example, beyond the material boundary of a light guide.

Relative position specifications such as “front” or “front side”, “in front of” or “behind”, “rear side”, “after”, “therebehind” and orientation specifications such as “top view”, “vertical”, “horizontal”, and the like refer in principle to a perspective which corresponds to the perspective of a user of a wall charging station installed on a wall. The mentioned specifications are used only to illustrate the present teaching on the basis of the exemplary embodiments described herein by way of example and are not restrictive.

The light-emitting cover section is designed or formed and configured in the sense of the present disclosure to emit light to the surroundings via its front side. The light-emitting cover section can be formed, for example, as a flat or curved surface. The light-emitting cover section can have, for example, a rectangular outer contour. Similarly, the light-emitting cover section can also have a circular outer contour or another outer contour which corresponds to a logo or a symbol to be depicted, for example. The light-emitting cover section can thus be specifically designed and produced for depicting a previously defined graphic.

The definition “emitted to the surroundings” in the sense of the present disclosure can mean that light is emitted to the surroundings via a front side of the light-emitting cover section. In particular, this can be understood as a light emission that is suitable to be incident as light in an eye of a user of the wall charging station of the present disclosure under normal handling of the wall charging station. In other words, in the sense of the present disclosure, the term “light-emitting cover section” means a “lighted area”, which is perceived as such by a user of the wall charging station.

A cover in the sense of the present disclosure can be understood as a sealing internal housing front part, also called “front cover”. In the sense of the present disclosure, a light-emitting cover section can likewise also mean a visible housing part located above it, which defines the shape of the housing toward the user and through which the light can be at least partially conducted. Such light-emitting cover sections are sometimes called “design cover”.

Because the light coupling point is arranged outside and behind the rear side of the light-emitting cover section, the original light source can be arranged in the interior of the wall charging station remotely from the actual location of the light emission to the surroundings. In other words, the functions “light coupling into the light coupling point” and “light emission to the surroundings” can be spatially separated from one another. It is therefore not necessary for the light coupling point and the light-emitting cover section to align with one another.

The light-emitting cover section can thus be formed in particular in areas used for communication, such as the display of RFID information or an operating state of the wall charging station. This can be advantageous, for example, if means for authorizing the energy consumption are provided in the cover according to the present disclosure, for example, via a coded RFID transponder or via a key switch, or other technical means which are suitable for identifying a user or acquiring information for invoicing purposes and possibly exchanging these data via data-carrying network connections with central devices.

Very generally formulated, the light-emitting cover section can thus be designed solely in consideration of those aspects which are essential for the display or light emission as such. In this regard, the display or light emission in the light-emitting cover section can fulfill various purposes. For example, the light-emitting cover section can solely be used as a light source. The light-emitting cover section can also meet aesthetic, informative, or technical functions or purposes.

The cover according to the present disclosure is intended to emit the largest possible proportion of the light that is coupled-in, particularly preferably all of the coupled-in light via the front side of the light-emitting cover section to the surroundings. The disadvantage of the low light power known from the prior art, which results from light coupled in outside and behind the light-emitting cover section, is overcome by providing the rear side of the light-emitting cover section having a light-reflecting element designed and configured to emit light incident from the light coupling point via the front side of the light-emitting cover section to the surroundings.

According to the present disclosure, the rear side of the light-emitting cover section is generally suitable for deflecting previously coupled-in light, thus totally reflected light, at the rear side and emitting it via the front side to the surroundings. The rear side is accordingly formed to provide a surface on which coupled-in light is incident at an angle that is greater than the associated limiting angle of the total reflection, so that previously coupled-in light is not deflected by total reflection at the rear side.

Multiple advantages are provided because the rear side of the light-emitting cover section has a light-reflecting element designed and configured to emit light incident from the light coupling point via the front side of the light-emitting cover section to the surroundings.

The presence of the light-reflecting element prevents light deflected at the rear side from leaving the light-emitting cover section via the rear side in the direction “inside of the wall charging station”. If no light-reflecting element were present, the deflection of the light taking place at the rear side, which is in particular not a total reflection at this point, would scatter light at least partially via the rear side of the light-emitting cover section. The light fractions scattered via the rear side of the light-emitting cover section would largely be light losses, since a user of the wall charging station only perceives light that is emitted to the surroundings via the front side of the light-emitting cover section.

The presence of the light-reflecting element on the rear side of the light-emitting cover section accordingly has the advantage that the amount of the light emitted via the front side to the surroundings is maximized. The light yield can thus be maximized and the required power of the light source can be minimized. In this way, it can be ensured that even with a moderate output power even in daylight, a clearly perceptible light flux can be achieved via the front side of the light-emitting cover section. The presence of the light-reflecting element on the rear side of the light-emitting cover section furthermore has the advantage that heating of the wall charging station due to light absorption is minimized. The safety of the wall charging station in operation is thus further improved.

The light-reflecting element can provide, for example, a mirrored surface, which is arranged abutting the rear side over the entire surface. According to this embodiment, light is literally reflected by means of the light-reflecting element arranged on the rear side of the light-emitting cover section, thus deflected corresponding to the angle of incidence.

According to an advantageous embodiment, the reflecting element can be made white and/or colored. In the meaning of the present disclosure, this means that the reflecting element provides a white and/or colored surface for light in the installed state, which is deflected within the light-emitting cover section coming from the light coupling point at the rear side of the light-emitting cover section.

Because the reflecting element is made white, light coming from the light coupling point can be scattered at the rear side of the light-emitting cover section in all directions on this side of the light-emitting cover section. The light emitted via the front side to the surroundings can thus be perceived as white light. Since the reflected light is scattered at the white reflecting element, the surface geometry of the rear side can have little to no influence on the perceived light from the light-emitting cover section. A homogeneous light emission in the light-emitting cover section can thus be achieved.

Because the reflecting element is made colored, light coming from the light coupling point can be colored at the rear side of the light-emitting cover section in accordance with the color of the reflecting element. A person skilled in the art also reads here that the resulting wavelength of the light emitted via the front side to the surroundings is dependent not only on the color of the reflecting element, but also on the wave spectrum of the light coupled in at the light coupling point and on further factors. It is apparent to a person skilled in the art from the statement above that depending on the application, combinations of differently designed reflecting elements are also conceivable.

According to a preferred embodiment, the light guiding element and the reflecting element can comprise plastic or can be produced or made from plastic, wherein the plastic can preferably comprise polycarbonate. In the sense of the present disclosure, the light guiding element and the reflecting element have to be produced from a transparent or at least translucent material. The use of plastic for the light guiding element and the reflecting element has the advantage over glass, for example, that production costs and weight can be saved. Furthermore, the inherent security of the wall charging station from external force action can thus be minimized.

The use of polycarbonate has the advantage that polycarbonate can be processed well using the methods typical for thermoplastics, due to which an efficient, cost-saving mass production can be enabled for moderate to high quantities. Furthermore, polycarbonates have a relatively high strength, impact resistance, rigidity, and hardness, such that the use as a material of the light guiding element and the reflecting element provides additional advantages. In addition, polycarbonates are good insulators with respect to electric current, so that also for this reason an advantageous effect in conjunction with a wall charging station can be used.

According to an embodiment, the light guiding element and the reflecting element can be produced by or using an injection molding method. The use of an injection molding method can ensure a cost-effective, simple, and easily reproducible production of the light guiding element and the reflecting element. These components can thus be produced in a simple manner as platform products.

In a preferred embodiment, the light guiding element and the reflecting element can be produced or made as a two-component plastic part. An unambiguous, simple, and secure component connection of the light guiding element to the reflecting element can thus primarily be ensured. In particular, it is thereby possible to prevent any moisture from penetrating between the light guiding element and the reflecting element in the area of the rear side of the light-emitting cover section, which could result in blinding of the light-emitting cover section. As a result, it can thus be achieved that the light-guiding part of the wall charging station can also have a protecting and sealing function for the electronic components present in the interior of the wall charging station.

The production of the light guiding element and the reflecting element as a two-component plastic part allows to provide these two parts having different or opposing functional requirements on the individual material components as a single composite component. If two materials are combined with one another, such as a transparent material and an opaque material having different hardness, this is referred to as two-component or 2C applications. Accordingly, 2C stands here for “two components” (for example: hard/soft), which are bonded to one another in the injection mold. The desired bonding/adhesion properties of the various materials can be achieved by a suitable material selection and appropriate geometric design of the adhesive surface in the injection mold. One essential advantage of 2C injection molding is the processing of both materials in an identical manufacturing method. Finishing or assembly of the two components is thus not necessary. Different materials of the light guiding element and the reflecting element can thus be implemented in one production method.

According to an advantageous embodiment, the light coupling point can be formed essentially parallel to a center plane of the light-emitting cover section. The center plane of the light-emitting cover section can extend, for example, along or parallel to the center plane of a front side of the cover. Because the light coupling point is formed essentially parallel to a center plane of the light-emitting cover section, the light guiding element can have essentially parallel boundary surfaces. Thereby, the production of the light guiding element can be significantly simplified. In addition, the light guiding element can thereby be integrated in a simple manner in a conventional wall charging station.

In an embodiment, the light guiding element can comprise a curved light guide, which is formed and configured to guide light from the light coupling point into the light-emitting cover section. Due to the use of a curved light guide, independently of the position of a light source within the wall charging station, light from this light source can be coupled into the light coupling point of the light guiding element and guided to the light-emitting cover section. Ultimately, the light coupling point can thus be arranged in a simple manner outside and behind the rear side of the light-emitting cover section. Furthermore, a fastening option of the light guiding element in the cover of the wall charging station can be provided by the use of a curved light guide.

According to an embodiment, the rear side of the light-emitting cover section can be made or formed convex or concave relative to the front side of the light-emitting cover section. By means of the convex or concave rear side of the light-emitting cover section, coupled-in light coming from the light coupling point can be incident on the rear side at an angle of incidence which is greater than the limiting angle of the total reflection. Coupled-in light can thus be emitted via a reflection at the rear side of the light-emitting cover section via the front side thereof as perceptible light to the surroundings.

According to an alternative and/or additional embodiment, the rear side of the light-emitting cover section can have a lattice, wherein the lattice can preferably be a diagonal lattice. Due to the presence of a lattice on the rear side of the light-emitting cover section, a uniform and substantially complete reflection and/or scattering of coupled-in light can be achieved on the rear side in an efficient manner. Furthermore, increased stability of the light-emitting cover section can be achieved by the lattice. The lattice can be introduced both in the form of bulges and also in the form of notches in the light-emitting cover section.

The embodiment of the lattice as a diagonal lattice has the advantage that when light coupled in via the light coupling point is incident laterally in the light-emitting cover section, this light is incident with a higher probability on a lattice strut in comparison to a perpendicularly arranged lattice.

According to embodiments of the present disclosure, the wall charging station can furthermore comprise a circuit board having light sources, wherein the light sources can be designed and configured to couple light into the light coupling point of the light element. In the sense of the present disclosure, the circuit board can be embodied as a printed circuit board, PCB. In this manner, an already existing circuit board of a conventional wall charging station can be supplemented with light sources and can thus generally be suitable to be combined with a cover having a light guiding element according to the present disclosure. Accordingly, conventional wall charging stations can therefore be retrofitted in a simple manner to form wall charging stations according to the present disclosure.

For example, the light source can have one or more LEDs. According to a preferred embodiment, the light source can be introduced integrally into the circuit board, such that the complexity of the cover can be further reduced because of component reduction.

According to an advantageous embodiment, the light-emitting cover section can furthermore comprise a display section, which is formed and configured to be entirely or partially illuminated by means of light sources arranged on the circuit board. Accordingly, the display section can be background illuminated in a conventional manner by means of light sources arranged on the circuit board. An additional illuminated display independent of the light-emitting cover section can thus be provided, via which information can be transmitted to the user of the wall charging station. The display section can comprise, for example, a progress bar, which indicates the progress of a charging process of an electric vehicle connected to the wall charging station. Alternatively or additionally, the display section can be designed and configured, for example, to display status information for the authorization of a user of the wall charging station.

In an embodiment, the display section can furthermore be formed and configured to emit information about the device status of the charging station. The charging process can thus be explained and carried out easily, unambiguously, and safely using the wall charging station, for example.

The wall charging station can thus be designed and configured, for example, to initially only display information about an illuminated display section to a user or potential user of the wall charging station via the display section. The user or potential user can infer from the illuminated display section, for example, that the wall charging station is generally functional. Furthermore, the wall charging station can be designed and configured to only supply the light-emitting cover section with light via the light coupling point when, for example, a successful authorization of a user has taken place. In this manner, a light-based communication with a user of the wall charging station can be implemented.

According to an advantageous embodiment, the cover of the wall charging station can be embodied as a half shell and can have fastening means for fastening the cover on a wall-side housing part. Wall charging stations of a conventional construction which have already been produced, sold, and/or have already been installed on a wall can thus be retrofitted in a simple manner to form a wall charging station according to the present disclosure. It is thus possible to avoid disposing of wall charging stations of a conventional construction, due to which waste production and environmental stresses can be reduced. Furthermore, it is thus possible to separate the wall-side housing part and the cover from one another. Housings and replaceable adapters to be disposed of can thus be supplied in a simple manner to the respective waste preparation processes, for example.

According to a first embodiment of the present disclosure, the light guiding element and/or the cover can be formed and configured so that the light guiding element is detachably arranged in the cover. This has the advantage that the light guiding element can be embodied in a customer-specific and/or application-specific manner. It is likewise thus possible to replace or exchange the light guiding element at any time of a wall charging station which has already been produced, sold, and/or has already been installed. In this manner, wall charging stations can be used multiple times and in different areas of application and/or different ownership conditions, in particular if a logo is to be displayed in the light-emitting cover section. Waste production and environmental stresses can thus be reduced. Furthermore, it is thus possible to separate the wall-side housing part and the cover from one another. Furthermore, it is thus possible to supply covers and light guiding elements to be disposed of in a simple manner to the respective waste preparation processes, for example.

In an embodiment, the cover of the wall charging station can furthermore comprise an opaque cover section. It is advantageous here that conventional opaque materials can be used for the opaque cover section, in particular plastic materials. Production costs can thus be reduced. A further advantage here is that deliberately only the light-emitting cover section or the externally visible light guiding element is visually highlighted, wherein the electrical components arranged in the interior of the wall charging station are not visually perceptible.

According to a second embodiment of the present disclosure, the opaque cover section, the light guiding element, and the reflecting element can all be produced from a three-component plastic part. This has the advantage that the entire cover of the wall charging station can be embodied as a single component. The cover of the wall charging station can thus fulfill a sealing function for the electrical components arranged in the interior of the wall charging station. The structural stability of the cover of the wall charging station can be significantly improved at the same time. The same advantages and principles apply for the production of the three-component plastic part as those for the advantages and principles described above in conjunction with the two-component plastic part.

A high level of mechanical strength and reliable leak-tightness can thus be achieved. For example, the cover can thus withstand pulsed shocks or the impact of objects with a certain minimum energy without safety losses. A sufficient level of safety for persons and valuable objects from electrical shock and fire can thus be ensured for a broader area of application. This measure thus protects in an improved manner from a safety-critical damage to the housing and thus from any touching of current-conducting parts by unaware, unauthorized, or incautious persons. Furthermore, this enables a simplification of the assembly.

Further advantages and features of the present invention are apparent from the following description of preferred exemplary embodiments. The features described therein can be implemented alone or in combination with one or more of the above-described features insofar as the features do not contradict one another. The following description of preferred exemplary embodiments is provided with reference to the appended Figures.

### BRIEF DESCRIPTION OF THE FIGURES

Preferred further embodiments of the invention are explained in more detail by the following description of the Figures. In the Figures:

FIG. 1 shows a schematic cross-sectional view of a portion of a cover of a wall charging station according to embodiments of the disclosure along a horizontal section plane;

FIG. 2 shows a schematic cross-sectional view of a portion of the cover according to FIG. 1 along a vertical section plane in an installed state;

FIG. 3 shows a perspective view of a cover according to embodiments of the disclosure;

FIG. 4 shows a schematic top view of the cover according to FIG. 3;

FIG. 5 shows a schematic rear view of the cover according to FIG. 4;

FIG. 6 shows a schematic top view of a light guiding element according to embodiments of the disclosure; and

FIG. 7 shows a schematic rear view of the light guiding element according to FIG. 6.

### DETAILED DESCRIPTION OF PREFERRED EXEMPLARY EMBODIMENTS

Preferred exemplary embodiments are described hereinafter on the basis of the Figures. Similar, identical, or identically acting elements in the different Figures are provided with identical reference signs and a repeated description of these elements is partially omitted to avoid redundancies.

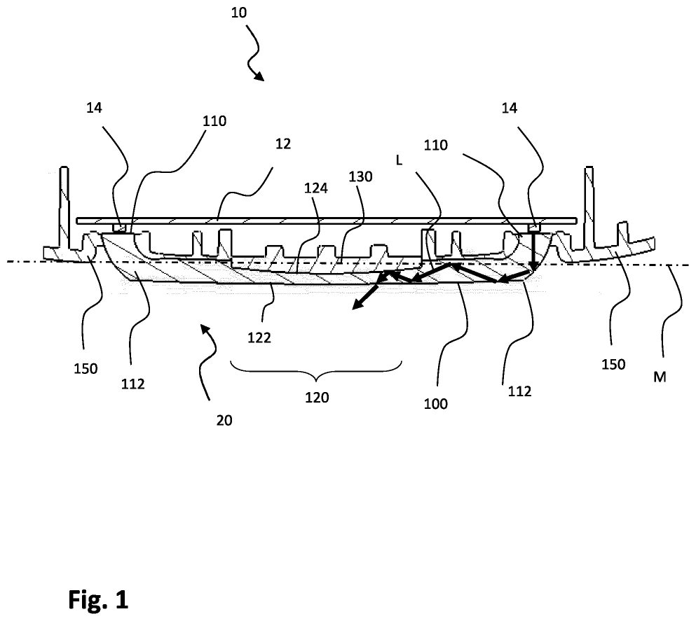

FIG. 1 shows a schematic cross-sectional view of a portion of a cover 20 of a wall charging station 10 according to embodiments of the disclosure along a horizontal section plane. The wall charging station 10 shown in FIG. 1 for charging electrical and hybrid vehicles comprises a cover 20 having a light guiding element 100, which comprises a light coupling point 110 and a light-emitting cover section 120 having a front side 122 and a rear side 124. The light coupling point 110 is arranged outside and behind the rear side 124. In other words, the light coupling point 110 is arranged in the interior of the wall charging station 10. Furthermore, the rear side 124 has a light-reflecting element 130, which is designed and configured to emit light L incident from the light coupling point 110 via the front side of the light-emitting cover section 100 to the surroundings.

According to the illustration shown in FIG. 1, the rear side 124 of the wall charging station 10 faces toward the inside of the wall charging station 10. The front side 122 of the wall charging station 10 likewise faces toward the surroundings.

The reflecting element 130 can be made white and/or colored. Furthermore, the light guiding element 100 and the reflecting element 130 can comprise plastic or can be produced from plastic, wherein the plastic comprises polycarbonate, for example. In particular, the light guiding element 100 and the reflecting element 130 can be produced using an injection molding method.

According to the exemplary embodiment shown in FIG. 1, the light guiding element 100 and the reflecting element 130 can be produced from a two-component plastic part.

The light coupling point 110 of the light guiding element 100 can be formed essentially parallel to a center plane M of the light-emitting cover section 120. Furthermore, the light guiding element 100 can comprise a curved light guide 112, which can be formed and configured to guide light L from the light coupling point 110 into the light-emitting cover section 120. The rear side 124 of the light-emitting cover section 120 can be formed convexly relative to the front side 122 of the light-emitting cover section 120. Likewise, according to a variant of the embodiment which is not shown, the rear side 124 of the light-emitting cover section 120 can be formed concavely relative to the front side of the light-emitting cover section.

The wall charging station 10 can furthermore have a circuit board 12 having light sources 14. The light sources can be designed and configured here to couple light L into the light coupling point 110 of the light guiding element 100. According to the variant of the embodiment depicted in FIG. 1, the circuit board 12 can have two vertical rows of light sources 14, wherein each vertical row of light sources 14 respectively comprises light sources 14 which are designed and configured to couple light L into the respectively adjoining light coupling point 110 of the light guiding element 100. In the depicted representation, a possible light flux L for one side of the light guiding element 100 is shown in schematically simplified form. Accordingly, light L can enter via a light source 14 arranged on the circuit board 12 in the adjoining light coupling point 110 of the light guiding element 100 into the light guiding element 100. Due to the light guide quality of the light guiding element 100 in this section, the light L can propagate along the curved light guide 112 through the light guiding element 100 with total reflection.

The light guide quality is deliberately no longer present in the light-emitting cover section 120. As soon as the light L is incident on the concave rear side 124 of the light-emitting cover section 120, it can be incident at an angle on the rear side 124 which is greater than the limiting angle for total reflection. Consequently, the light L incident on the rear side 124 is therefore deflected. Because of the fact that the rear side 124 has a light-reflecting element 130, light L incident on the rear side 124 can only be deflected in a direction of the front side 122. The light L incident on the rear side 124 is thus deflected by the light-reflecting element 130 so that it is emitted to the surroundings via the front side 110 of the light-emitting cover section 100.

In the exemplary embodiment shown, the light-reflecting element 130 is formed in one piece with the light-emitting cover section 120. This can be achieved, for example, in that initially the light-reflecting element 130 is injection molded in a first mold, for example, from an opaque, white plastic material. The light-reflecting element 130 produced in this manner is then laid in a further mold and a transparent material is injection molded therein in order to form the light-emitting cover section 120 in this manner, in which the light-reflecting element 130 is embedded. In other words, the light-emitting cover section 120 is produced as a 2C part together with the light-reflecting element 130.

According to the embodiment depicted in FIG. 1, the light guiding element 100 and/or the cover 20 can be designed and configured so that the light guiding element 100 is detachably arranged in the cover 20. The cover 20 can comprise an opaque cover section 150.

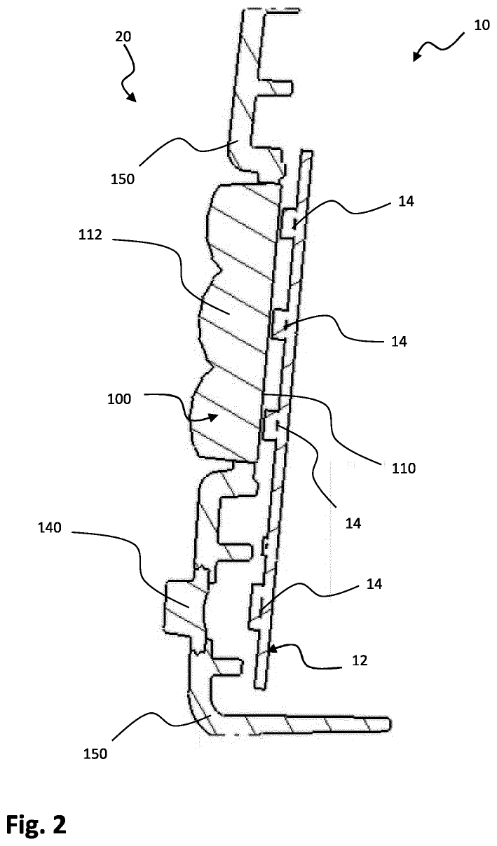

FIG. 2 shows a schematic cross-sectional view of a portion of the cover 20 according to FIG. 1 along a vertical section plane. The section plane depicted in FIG. 2 extends through a curved light guide 112 of the light guiding element 100. In FIG. 2, the cover 20 is accordingly shown together with the light guiding element 100. The light guiding element 100 has the light coupling point 110 and the light-emitting cover section 120 (not shown here). It is apparent from the depiction in FIG. 2 how the light coupling point 110 can be arranged on the curved light guide 112. In addition, it is apparent from the depiction in FIG. 2 how the light coupling point 110 can interact with the light sources 14 of the circuit board 12. In particular, a gap can be formed between the light coupling point 110 and the light sources 14 adjoining the light coupling point 110. With regard to the representation of FIG. 1, the plane of section of the representation in FIG. 2 extends along a vertical row of light sources 14 which are arranged on the circuit board 12.

According to the depiction in FIG. 2, the light guiding element 100 can furthermore comprise a display section 140, which is designed and configured to be entirely or partially illuminated by means of light sources 14 arranged on the circuit board 12. According to the representation depicted in FIG. 2, the display section 140 can be backlit in a conventional manner by the light source 14. In other words, according to the representation depicted here, no light coupling in the sense of the present disclosure takes place between the light source 14 and the display section 140. Furthermore, an opaque cover section 51 of the cover 20 is shown.

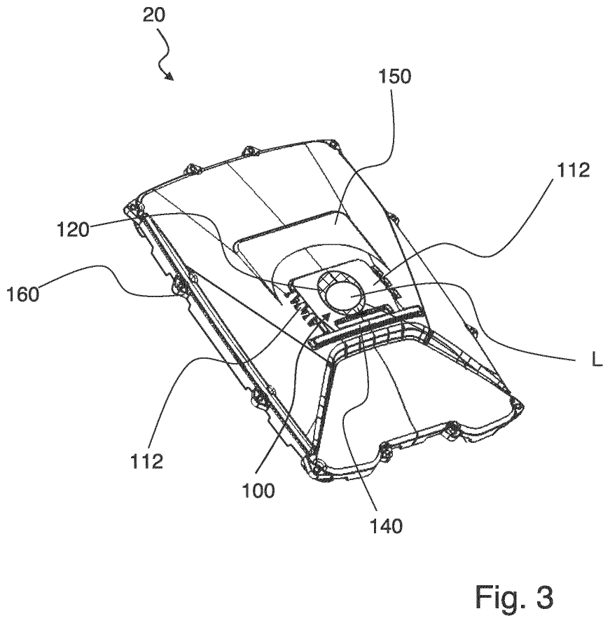

FIG. 3 shows a perspective view of a cover 20 according to embodiments of the disclosure. The cover 20 is shown together with the light element 100. The front side 122 of the light-emitting cover section 120 is recognizable from the depicted representation. A diagonal lattice of the light-emitting cover section 120 formed on the rear side of the light-emitting cover section is only indicated here. Light L can be emitted to the surroundings via the front side 122. Furthermore, two curved light guides 112 are shown in the depiction shown, which each extend laterally to the light-emitting cover section 120. With the exception of the light guiding element 100, the cover 20 is formed as an opaque cover section 150. Furthermore, the display section 140 is shown, which is designed and configured to be entirely or partially illuminated by means of light sources arranged on the circuit board (not shown in FIG. 3). Furthermore, it is shown that the cover 20 can have multiple fastening means 160.

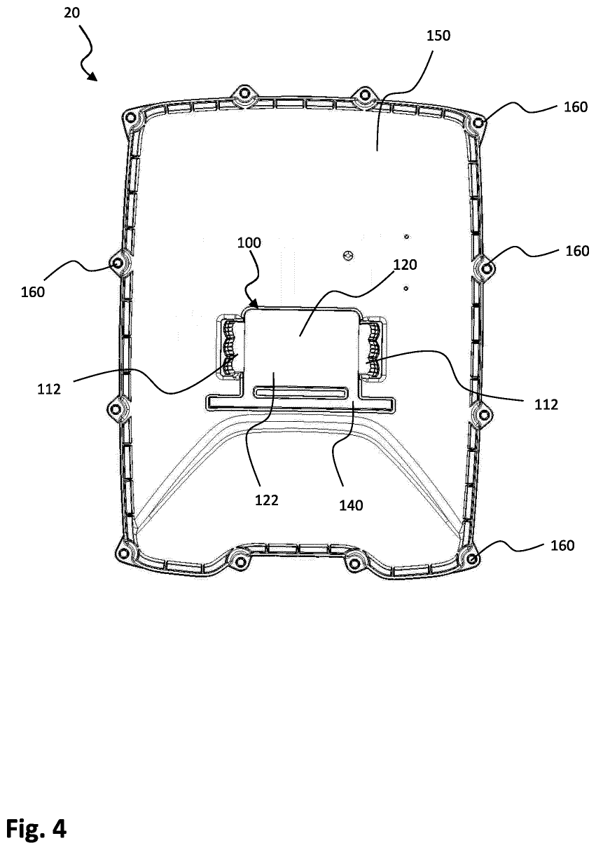

FIG. 4 shows a schematic top view of the cover 20 according to FIG. 3. This representation therefore has the same features as the depiction of FIG. 3. Furthermore, it can be seen from the depiction in FIG. 4 that the light guiding element 100 and/or the cover 20 can be designed and configured so that the light guiding element 100 can be detachably arranged in the cover 20. According to the depicted representation, the light guiding element 100 can be integrated along the display section 140, along the curved light guide 112, and along an upper edge of the light-emitting cover section 120 in the opaque cover section 150. The opaque cover section 150, however, can have multiple fastening means 160, via which the cover 20 can be assembled with a wall-side housing part of the wall charging station (not shown).

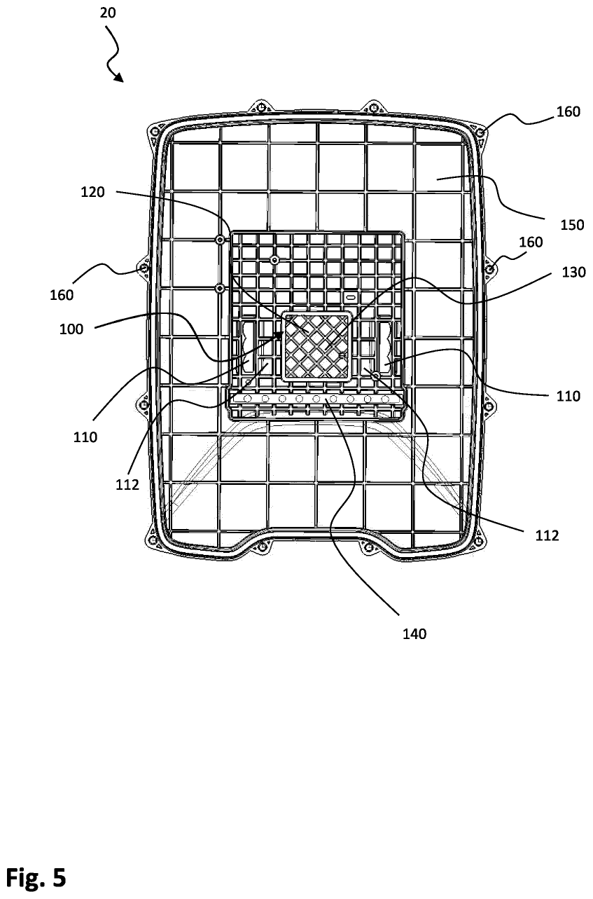

FIG. 5 shows a schematic rear view of the cover according to FIG. 3. It can be seen from the depiction in FIG. 5 how the light guiding element 100 can be integrated into the opaque cover section 150. It can be seen that the light coupling points 110, the reflecting element 130, and the display section 140 can pass through the opaque cover section 150. All other components of the light guiding element 100 can accordingly be formed on an outside of the opaque cover section 150.

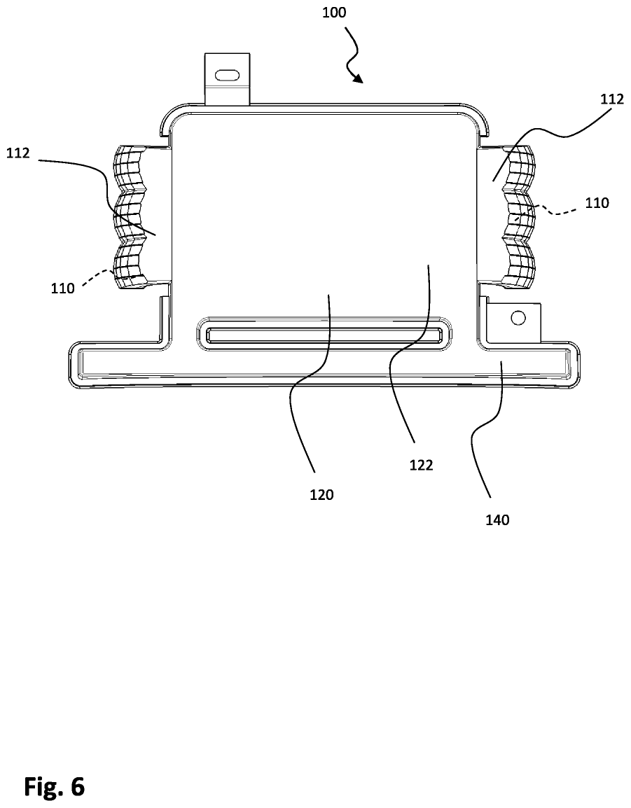

FIG. 6 shows a schematic top view of a light guiding element 100 according to embodiments of the disclosure. The light guiding element 100 can accordingly have two light coupling points 110 and one light-emitting cover section 120. In the depiction shown, only the front side 122 of the light-emitting cover section 120 is shown. The light guiding element 100 can be produced here from plastic, wherein the plastic can comprise polycarbonate, for example. For example, the light guiding element 100 can be produced by means of an injection molding method. Furthermore, two curved light guides 112 are shown in FIG. 6, which can be formed and configured to conduct light in the light-emitting cover section 120. Furthermore, the display section 140 is shown in FIG. 6, which can be formed and configured to be entirely or partially illuminated by means of light sources 14 (not shown here) arranged on the circuit board 12 (also not shown here).

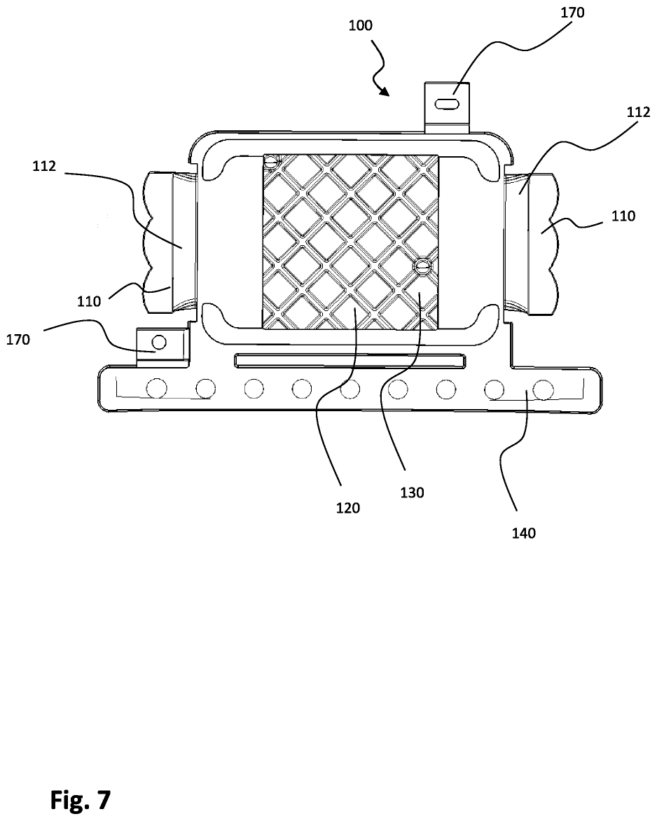

FIG. 7 shows a schematic rear view of the light guiding element 100 according to FIG. 6. Additionally to the depiction of FIG. 6, the reflecting element 130 is shown in the depiction of FIG. 7, which is arranged on the rear side 124 (not shown here) of the light-emitting cover section 120. It accordingly results from the consideration together of the depictions in FIG. 6 and FIG. 7 that the rear side 124 of the light-emitting cover section 120 is arranged between the front side and the light-reflecting element 130. Furthermore, it is indicated in the depiction in FIG. 7 that the display section 140 can be illuminated by multiple light sources. In addition, the light guiding element 100 can comprise assembly means 170, via which the light guiding element 100 can be assembled with the opaque cover section (not shown here).

Where applicable, all individual features which are represented in the exemplary embodiments can be combined and/or exchanged with one another without departing from the scope of the invention.

### LIST OF REFERENCE NUMERALS

L light
M center plane of the light-emitting section
10 wall charging station
12 circuit board
14 light source
20 cover
100 light guiding element
110 light coupling point
112 curved light guide
120 light-emitting cover section
122 front side of the light-emitting cover section
124 rear side of the light-emitting cover section
130 light-reflecting element
140 display section
150 opaque cover section
160 fastening means
170 assembly means

1. A wall charging station for charging electric and hybrid vehicles, comprising a cover having a light guiding element, which comprises a light coupling point and a light-emitting cover section having a front side (122) and a rear side,
wherein the rear side has a light-reflecting element, which is formed and configured to emit light incident from the light coupling point via the front side of the light-emitting cover section to the surroundings.

2. The wall charging station according to claim 1, wherein the reflecting element is made at least one of: white and colored.

3. The wall charging station according to claim 1, wherein the light guiding element and the reflecting element comprise plastic.

4. The wall charging station according to claim 3, wherein the light guiding element and the reflecting element are made by an injection molding method.

5. The wall charging station according to claim 3, wherein the light guiding element and the reflecting element are made from a two-component plastic part.

6. The wall charging station according to claim 1, wherein the light coupling point is formed essentially parallel to a center plane of the light-emitting cover section.

7. The wall charging station according to claim 6, wherein the light guiding element comprises a curved light guide, which is formed and configured to conduct light from the light coupling point into the light-emitting cover section.

8. The wall charging station according to claim 1, wherein the rear side of the light-emitting cover section is formed at least one of: convex and concave relative to the front side of the light-emitting cover section.

9. The wall charging station according to claim 1, wherein the rear side of the light-emitting cover section has a lattice.

10. The wall charging station according to claim 1, further comprising a circuit board having light sources, wherein the light sources are formed and configured to couple light into the light coupling point of the light guiding element.

11. The wall charging station according to claim 10, wherein the light guiding element further comprises a display section, which is formed and configured to be at least one of: entirely and partially illuminated by means of light sources arranged on the circuit board.

12. The wall charging station according to claim 1, wherein the cover is formed as a half shell and comprises fastening means for fastening the cover on a wall-side housing part.

13. The wall charging station according to claim 1, wherein at least one of: the light guiding element and the cover are formed and configured so that the light guiding element is detachably arranged in the cover.

14. The wall charging station according to claim 1, wherein the cover further comprises an opaque cover section.

15. The wall charging station according to claim 14, wherein the opaque cover section, the light guiding element, and the reflecting element are made from a three-component plastic part.

16. The wall charging station according to claim 3, wherein the plastic comprises polycarbonate.

17. The wall charging station according to claim 9, wherein the lattice is a diagonal lattice.
